(19) United States
(12) Patent Application Publication
(10) Pub. No.: US 2020/0389712 A1
(43) Pub. Date: Dec. 10, 2020

(54) IoT NETWORK ARCHITECTURE AND WAVELENGTH DIVISION IoT GATEWAY DEVICE THEREOF

(71) Applicant: Agileiots Investment Co., Ltd., Taoyuan City (TW)

(72) Inventor: HUNG-HSIANG CHIANG, Kaohsiung City (TW)

(21) Appl. No.: 16/897,995

(22) Filed: Jun. 10, 2020

(30) Foreign Application Priority Data
Jun. 10, 2019 (TW) 108119996

(51) Int. Cl. H04Q 11/00; H04L 12/66; H04L 12/10

(52) U.S. Cl. CPC H04Q 11/0005; H04Q 11/0067; H04L 12/66; H04Q 2011/0016; H04Q 2213/13196; H04Q 2213/13034; H04L 12/10

(57) ABSTRACT

An IoT network architecture and wavelength division IoT gateway device is provided in the invention includes an optical de-multiplexer and an optical multiplexer that use wavelengths for multiplexing, such that information from different sources can be transmitted on the same optical fiber at different wavelengths in an optical network, thereby greatly improving bandwidth benefits of network information transmission and communication capacity of the gateway device so as to fulfill increasing local communication service requirements and further enhance IoT applications.

### CROSS-REFERENCE TO RELATED APPLICATIONS

This application claims the priority of Republic of China Patent Application No. 108119996 filed on Jun. 10, 2019, in the State Intellectual Property Office of the R.O.C., the disclosure of which is incorporated herein by reference.

### BACKGROUND OF THE INVENTION

### Field of the Invention

The present invention relates to communication facility fields, and more particularly, to an IoT network architecture for increasing communication capacity and a wavelength division IoT gateway device thereof.

### Descriptions of the Related Art

5G technology is booming globally, and it is expected that 5G is networked to everything in the future. Telecommunications providers have greatly upgraded current 4G (LTE) technology and widely applied Internet of Things (IoT) to infrastructures, supply chain logistics, asset management, environmental monitoring, etc.

Nowadays using mobile phones is so popular with mature and multiple 4G services being provided. For example, it is very convenient that people can use their mobile phones to check bus arriving timetables for nearby bus stops or look up estimated waiting time for their doctor appointments. The innovation of 5G technology leads to broad application of networking and IoT, such that IoT deployment becomes important. IoT deployment usually requires gateway devices to serve as common access points for different levels of networks such as local area network (LAN) and wide area network (WAN). IoT deployment is however often restricted by communication capacity of a gateway device that is for data transmission.

If communication capacity of the gateway device is insufficient, local communication service requirements, which are increasing, cannot be fulfilled. An effective solution is to extensively build up gateway devices. It however becomes very difficult for the telecommunications providers to find where to locate the gateway devices as urban public land is getting less and less due to rapid urban development.

Therefore, how to increase communication capacity of a gateway device to fulfill increasing local communication service requirements, is an important task in the art.

### SUMMARY OF THE INVENTION

In view of the above drawbacks in the prior art, a primary object of the present invention is to provide an IoT network architecture and a wavelength division IoT gateway device thereof, the IoT network architecture and wavelength division IoT gateway device is used wavelengths for multiplexing, thereby greatly improving bandwidth benefits of network information transmission and communication capacity of the gateway device so as to fulfill increasing local communication service requirements and further enhance IoT applications.

To achieve the above and other objects, a wavelength division IoT gateway device is provided in the invention, the wavelength division IoT gateway device including: a gateway body including an input optical transceiver port, an input power port, a first output optical transceiver port, a second output optical transceiver port, a first output power port and a second output power port, wherein the input optical transceiver port is for receiving and sending a network optical signal, and the input power port is for receiving an input power signal; an optical add/drop multiplexer (OADM) for retrieving an input integrated optical signal, which meets a predetermined input wavelength range, from the network optical signal, or for incorporating an output integrated optical signal, which meets a predetermined output wavelength range, into the network optical signal; an optical de-multiplexer (DMUX) for breaking down the input integrated optical signal into a first input optical signal and a second input optical signal, which are to be transmitted to the first output optical transceiver port and the second output optical transceiver port respectively; an optical multiplexer (MUX) for receiving a first output optical signal from the first output optical transceiver port and receiving a second output optical signal from the second output optical transceiver port, and for incorporating the first output optical signal and the second output optical signal into the output integrated optical signal; and a power distribution panel (PDP) for breaking down the input power signal into a first input power signal and a second input power signal, which are to be transmitted to the first output power port and the second output power port respectively.

According to another purpose of the invention, another wavelength division IoT gateway device is provided in the invention including: a gateway body including an input optical transceiver port, an input power port, a first output optical transceiver port, a second output optical transceiver port, a first output power port and a second output power port, wherein the input optical transceiver port is for receiving and sending a network optical signal, and the input power port is for receiving an input power signal; an optical de-multiplexer (DMUX) for breaking down the network optical signal into a first input optical signal and a second input optical signal, which are to be transmitted to the first output optical transceiver port and the second output optical transceiver port respectively; an optical multiplexer (MUX) for receiving a first output optical signal from the first output optical transceiver port and receiving a second output optical signal from the second output optical transceiver port, wherein the first output optical signal and the second output optical signal are to be incorporated into the network optical signal; and a power distribution panel (PDP) for breaking down the input power signal into a first input power signal and a second input power signal, which are to be transmitted to the first output power port and the second output power port respectively.

Preferably, in the wavelength division IoT gateway device said above, further including: a network selection module connected to a first optical network and a second optical network respectively, wherein when the first optical network operates normally, the network selection module couples the first optical network to the input optical transceiver port to allow receiving and sending of the network optical signal; when the first optical network operates abnormally, the network selection module couples the second optical network to the input optical transceiver port to allow receiving and sending of the network optical signal.

Preferably, in the wavelength division IoT gateway device said above, wherein abnormality of the first optical network means the first optical network's optical power lower than a standard value.

Preferably, in the wavelength division IoT gateway device said above, wherein the network selection module at least is composed of an optical switch (OSW) and an optical splitter (OSP) or the network selection module at least is composed of a plurality of OSWs.

Preferably, in the wavelength division IoT gateway device said above, further including: a Power Over Ethernet (POE) module, wherein the DMUX is for further breaking down the input integrated optical signal into a fourth input optical signal that is to be transmitted to the POE module; the MUX is further for receiving a fourth output optical signal from the POE module and then for incorporating the fourth output optical signal into the output integrated optical signal; the PDP is for further breaking down the input power signal into a fourth input power signal that is to be transmitted to the POE module.

Preferably, in the wavelength division IoT gateway device said above, wherein the fourth input power signal is a first AC signal, and the wavelength division IoT gateway device further includes a first AC to DC conversion module for converting the fourth input power signal from the first AC signal to a first DC signal, allowing the POE module to receive the fourth input power signal that is the first DC signal.

Preferably, in the wavelength division IoT gateway device said above, wherein the input power signal is a second AC signal, and the wavelength division IoT gateway device further includes a second AC to DC conversion module for converting the input power signal from the second AC signal into a second DC signal, so as to allow PDP to receive the converted the input power signal that is the second DC signal.

Preferably, in the wavelength division IoT gateway device said above, wherein the input optical transceiver port and the input power port can be integrally formed in a first optoelectric hybrid cable connector; the first output optical transceiver port and the first output power port can be integrally formed in a second optoelectric hybrid cable connector; the second output optical transceiver port and the second output power port can be integrally formed in a third optoelectric hybrid cable connector.

Preferably, in the wavelength division IoT gateway device said above, further including: a network signal processing module, wherein the network signal processing module is located between the DMUX and the first output optical transceiver port and second output optical transceiver port, and is for respectively processing the first input optical signal and the second input optical signal transmitted to the first output optical transceiver port and the second output optical transceiver port, and wherein the network signal processing module is located between the MUX and the first output optical transceiver port and the second output optical transceiver port, and is for respectively processing the first output optical signal and the second output optical signal received by the first output optical transceiver port and the second output optical transceiver port.

Furthermore, the present invention provides an IoT network architecture including: the wavelength division IoT gateway device said above; a first antenna module coupled to the first output optical transceiver port and the first output power port, for receiving the first input optical signal from the first output optical transceiver port and for providing the first output optical signal to the first output optical transceiver port; a second antenna module coupled to the second output optical transceiver port and the second output power port, for receiving the second input optical signal from the second output optical transceiver port, and for providing the second output optical signal to the second output optical transceiver port; a power supply module coupled to the input power port, for providing the input power signal to the input power port; and an optical network module coupled to the input optical transceiver port, for providing the network optical signal to the input optical transceiver port.

Preferably, in the IoT network architecture said above, further comprising: a optoelectric conversion module for converting the first input optical signal into an electric signal that is to be received by the first antenna module, and for converting an outputted electric signal into the first output optical signal that is to be provided by the first antenna module the second input optical signal into an electric signal that is to be received by the second antenna module, and for converting an outputted electric signal into the second output optical signal that is to be provided by the second antenna module.

Preferably, in the IoT network architecture said above, the power supply module is an AC supply module.

Preferably, in the IoT network architecture said above, further including: a street light for carrying the wavelength division IoT gateway device, the first antenna module, the second antenna module, the power supply module or the optical network module.

Preferably, in the IoT network architecture said above, the street light can be composed of a plurality of poles that are arranged to form a receiving space for accommodating the wavelength division IoT gateway device, the power supply module or the optical network module.

Preferably, in the IoT network architecture said above, the power supply module is a DC supply module. The DC supply module includes a power control unit, and at least one of a battery, a DC input port and a solar panel, wherein the at least one of the three components serves as a DC power supply, the power control unit is used to receive DC power and provide the input power signal to the input power port.

Preferably, in the IoT network architecture said above, the power control unit is also provide power to the street light to control lightness of the street light.

Preferably, in the IoT network architecture said above, further includes a third antenna module, wherein the DMUX is used to further break down the input integrated optical signal into a third input optical signal that is to be transmitted to the third antenna module. The MUX is further used to receive the third output optical signal from the third antenna module and then incorporate the third output optical signal into the output integrated optical signal. The PDP is used to further break down the input power signal into a third input power signal that is to be transmitted to the third antenna module.

Preferably, in the IoT network architecture said above, the first antenna module includes a first Active Antenna Unit (AAU), the second antenna module includes a second AAU, the third antenna module includes a third AAU.

Preferably, in the IoT network architecture said above, the first antenna module includes a first passive antenna unit (PAU) and a first remote radio unit (RRU), the second antenna module includes a second PAU and a second RRU, the third antenna module includes a third PAU and a third RRU.

According to another purpose of the invention, another IoT network architecture is provided in the invention including: a first remote network equipment, a local network equipment and a first optical network, the first optical network connected the first remote network equipment and the local network equipment. And a second optical network is for connecting the first remote network equipment and the local network equipment. Wherein the local network equipment includes a wavelength division IoT gateway device, and the wavelength division IoT gateway device also includes a network selection module connected to the first optical network and the second optical network respectively. When the first optical network operates normally, the network selection module selectively couples the first optical network to the input optical transceiver port so as to allow the network optical signal to be received and sent among the first remote network equipment and the local network equipment through the first optical network. When the first optical network does not operate normally, the network selection module selectively couples the second optical network to the input optical transceiver port so as to allow the network optical signal to be received and sent among the first remote network equipment and the local network equipment through the second optical network.

The IoT network architecture is also provided in the invention including: a first remote network equipment, a local network equipment, a second remote network equipment, a first optical network and a second optical network, the first optical network is sequentially connected to the first remote network equipment, the local network equipment and the second remote network equipment, and the second optical network is sequentially connected to the first remote network equipment, the local network equipment and the second remote network equipment. Wherein the local network equipment includes a wavelength division IoT gateway device, and the wavelength division IoT gateway device also includes a network selection module connected to the first optical network and the second optical network respectively. When the first optical network operates normally, the network selection module selectively couples the first optical network to the input optical transceiver port so as to allow the network optical signal to be received and sent among the first remote network equipment, the local network equipment and the second remote network equipment through the first optical network. When the first optical network does not operate normally, the network selection module selectively couples the second optical network to the input optical transceiver port so as to allow the network optical signal to be received and sent among the first remote network equipment, the local network equipment and the second remote network equipment through the second optical network.

In summary, the IoT network architecture and wavelength division IoT gateway device is provided in the invention includes an optical de-multiplexer and an optical multiplexer that use wavelengths for multiplexing, such that information from different sources can be transmitted on the same optical fiber at different wavelengths in an optical network, thereby greatly improving bandwidth benefits of network information transmission and communication capacity of the gateway device so as to fulfill increasing local communication service requirements and further enhance IoT applications. Moreover, the IoT network architecture of the present invention further includes a street light composed of a plurality of poles that are arranged for easily mounting hardware equipment.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is basic system architectural block diagrams of an IoT network architecture according to the first embodiment of the present invention.

FIG. 2 is basic system architectural block diagrams of an IoT network architecture according to the second embodiment of the present invention.

FIG. 3 is basic system architectural block diagrams of an IoT network architecture according to the third embodiment of the present invention.

FIG. 4 is basic system architectural block diagrams of an IoT network architecture according to the fourth embodiment of the present invention.

FIG. 5 is basic system architectural block diagrams of an IoT network architecture according to the fifth embodiment of the present invention.

FIG. 6 is basic system architectural block diagrams of an IoT network architecture according to the sixth embodiment of the present invention.

FIG. 7 is a schematic diagram showing a usage status of applying the IoT network architecture to a street light according to the present invention.

FIG. 8 is basic system architectural block diagrams of an IoT network architecture according to the seventh embodiment of the present invention.

FIG. 9 is basic system architectural block diagrams of an IoT network architecture according to the eighth embodiment of the present invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

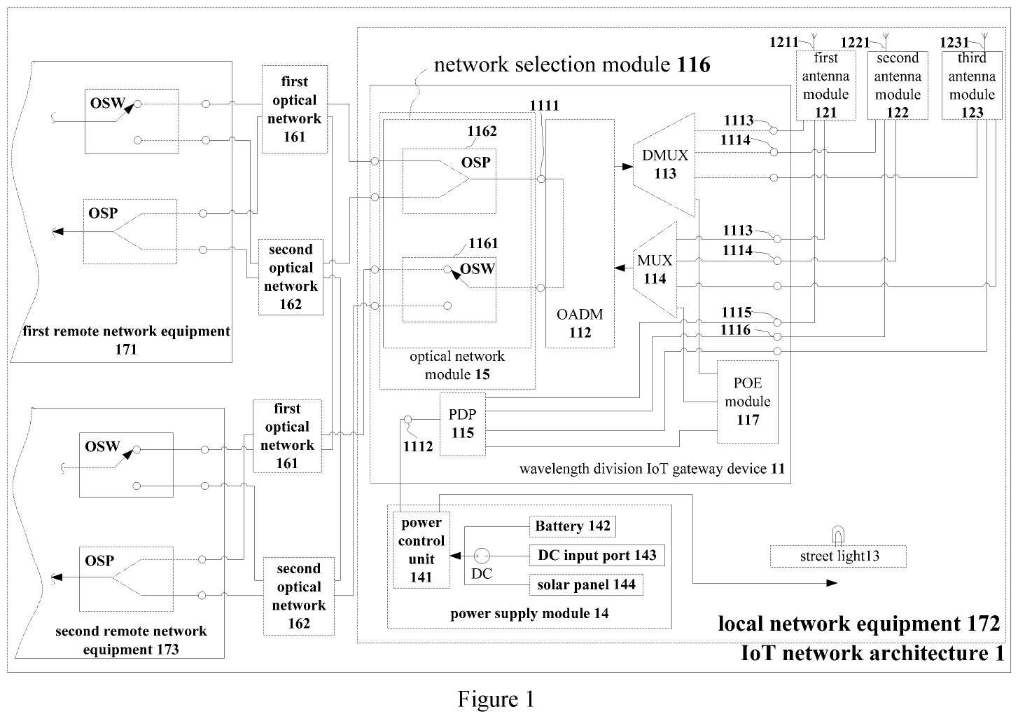

The present invention provides an IoT network architecture for increasing communication capacity and a wavelength division IoT gateway device thereof. The present invention is described below according to its preferred embodiments with reference to FIGS. 1 to 9.

In order to make the disclosure more concise and easier to understand, the same or similarly functioning elements in the following embodiments will be described with the same symbols, and the description of the same or equivalent features will be omitted.

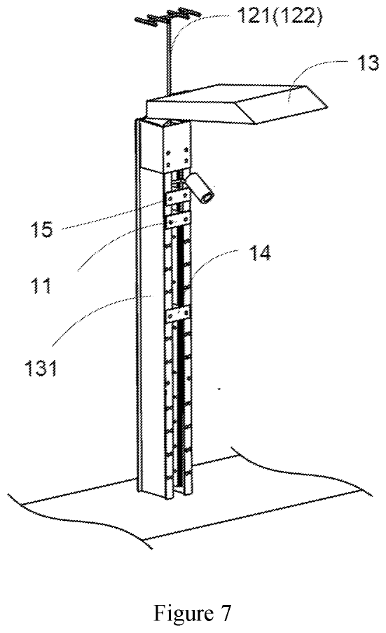

As shown in FIGS. 1, 3 and 5, an IoT network architecture 1 is applied to ring network architecture, and includes: a first antenna module 121, a second antenna module 122, a street light 13, a power supply module 14, an optical network module 15, a first optical network 161, a second optical network 162, first remote network equipment 171, local network equipment 172 and second remote network equipment 173. The local network equipment 172 includes a wavelength division IoT gateway device 11. The street light 13 carries the wavelength division IoT gateway device 11, the first antenna module 121 and the second antenna module 122, the power supply module 14 or the optical network module 15. As shown in FIG. 7, the street light 13 can be composed of a plurality of poles 131 that are arranged to form a receiving space for accommodating hardware equipment, for example, the wavelength division IoT gateway device 11, the power supply module 14 or the optical network module 15, etc.

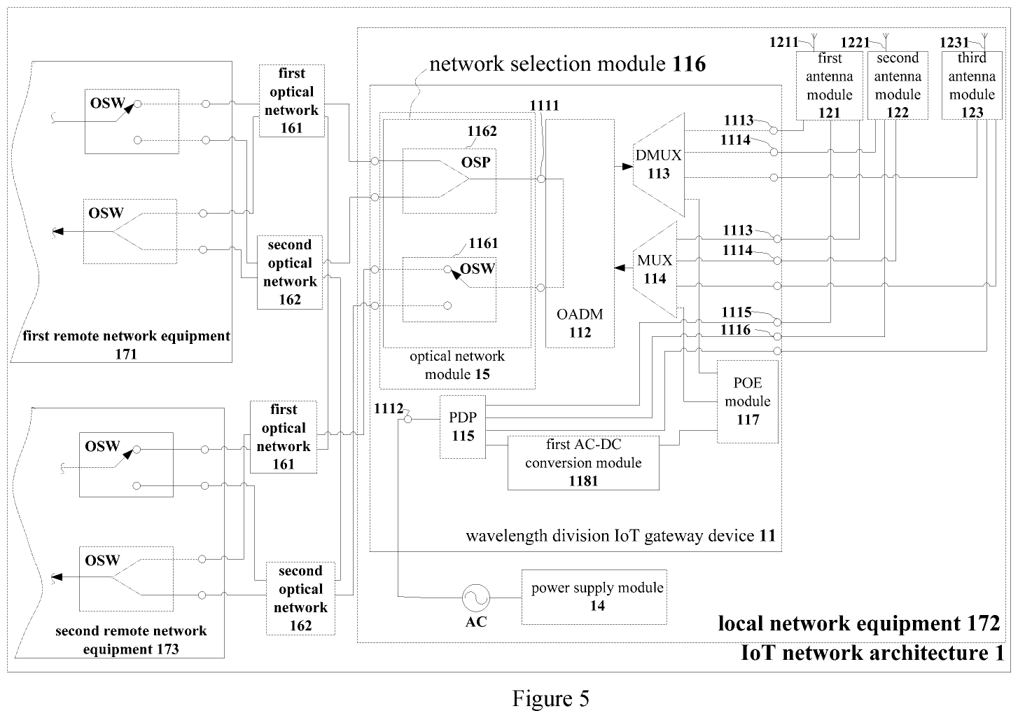

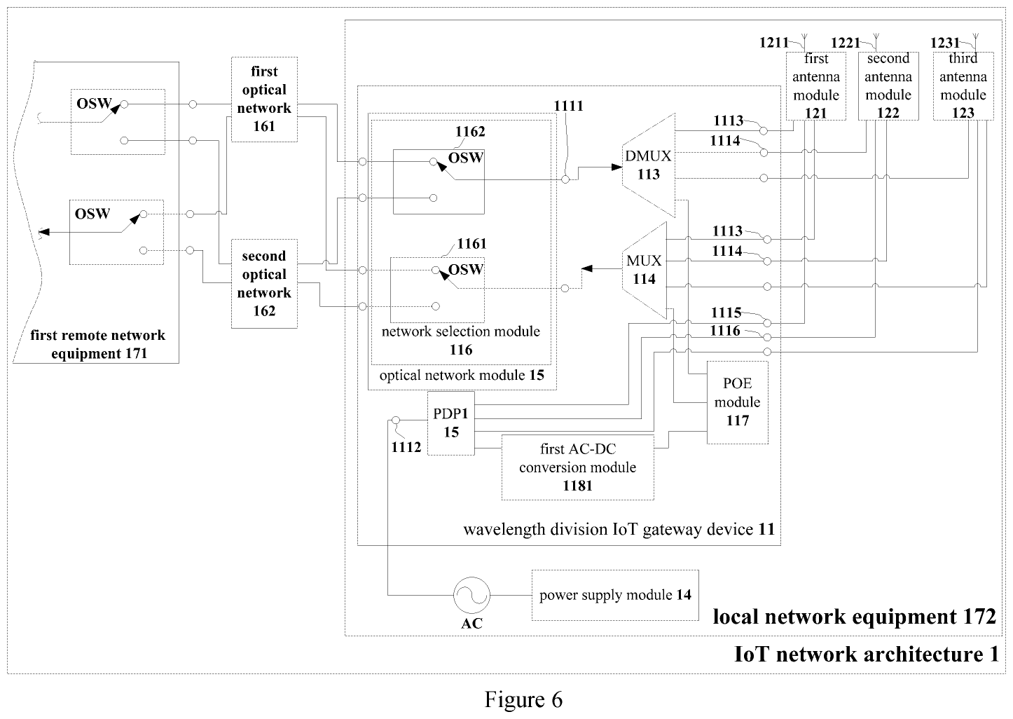

The first optical network 161 is sequentially connected to the first remote network equipment 171, the local network equipment 172 and the second remote network equipment 173. The second optical network 162 is sequentially connected to the first remote network equipment 171, the local network equipment 172 and the second remote network equipment 173. The wavelength division IoT gateway device 11 includes a network selection module 116 connected to the first optical network 161 and the second optical network 162 respectively. As shown in FIGS. 1 to 4, the network selection module 116 at least is composed of an optical switch (OSW) 1161 and an optical splitter (OSP) 1162. It is not limited to such a configuration. As shown in FIGS. 5 to 6, the network selection module 116 at least is composed of a plurality of OSWs 1161.

The wavelength division IoT gateway device 11 further includes: a gateway body, an optical add/drop multiplexer (OADM) 112, an optical de-multiplexer (DMUX) 113, an optical multiplexer (MUX) 114 and a power distribution panel (PDP) 115.

As shown in FIG. 1, the gateway body is formed with an input optical transceiver port 1111, an input power port 1112, a first output optical transceiver port 1113, a second output optical transceiver port 1114, a first output power port 1115 and a second output power port 1116. The input optical transceiver port 1111 is used to receive and send a network optical signal. The PDP 15 is coupled to the input optical transceiver port 1111, and is used to provide the network optical signal to the input optical transceiver port 1111.

In order to reduce manufacturing complexity, the input optical transceiver port 1111 and the input power port 1112 can be integrally formed in a first optoelectric hybrid cable connector; the first output optical transceiver port 1113 and the first output power port 1115 can be integrally formed in a second optoelectric hybrid cable connector; the second output optical transceiver port 1114 and the second output power port 1116 can be integrally formed in a third optoelectric hybrid cable connector.

When the first optical network 161 operates normally, the network selection module 116 selectively couples the first optical network 161 to the input optical transceiver port 1111 so as to allow the network optical signal to be received and sent among the first remote network equipment 171, the local network equipment 172 and the second remote network equipment 173 through the first optical network 161. When the first optical network 161 does not operate normally, the network selection module 116 selectively couples the second optical network 162 to the input optical transceiver port 1111 so as to allow the network optical signal to be received and sent among the first remote network equipment 171, the local network equipment 172 and the second remote network equipment 173 through the second optical network 162. Thus, the network selection module 116 prevents receiving and sending of the network optical signal from being affected by abnormality of the first optical network 161. Abnormality of the first optical network 161 means its optical power lower than a standard value.

The OADM 112 is used to retrieve an input integrated optical signal, which meets a predetermined input wavelength range, from the network optical signal, or to incorporate an output integrated optical signal, which meets a predetermined output wavelength range, into the network optical signal.

The DMUX 113 is used to break down optical signals that are transmitted on the same optical fiber at different wavelengths (i.e. optical wavelengths), so as to break down the input integrated optical signal into a first input optical signal and a second input optical signal with different wavelengths, which are to be transmitted to the first optical transceiver port 1113 and the second output optical transceiver port 1114 respectively.

The MUX 114 is used to receive a first output optical signal and a second output optical signal respectively from the first optical transceiver port 1113, the second output optical transceiver port 1114 and incorporate the received the first output optical signal and the second output optical signal into the output integrated optical signal for them to be transmitted on the same optical fiber. Compared to the first input optical signal and the second input optical signal, the first output optical signal and the second output optical signal can have same or different wavelengths.

The input power port 1112 is used to receive an input power signal. The power supply module 14 is coupled to the input power port 1112, and is used to provide the input power signal to the input power port 1112. The PDP 115 is used to break down the input power signal into a first input power signal and a second input power signal, which are to be transmitted to the first output power port 1115 and the second output power port 1116 respectively.

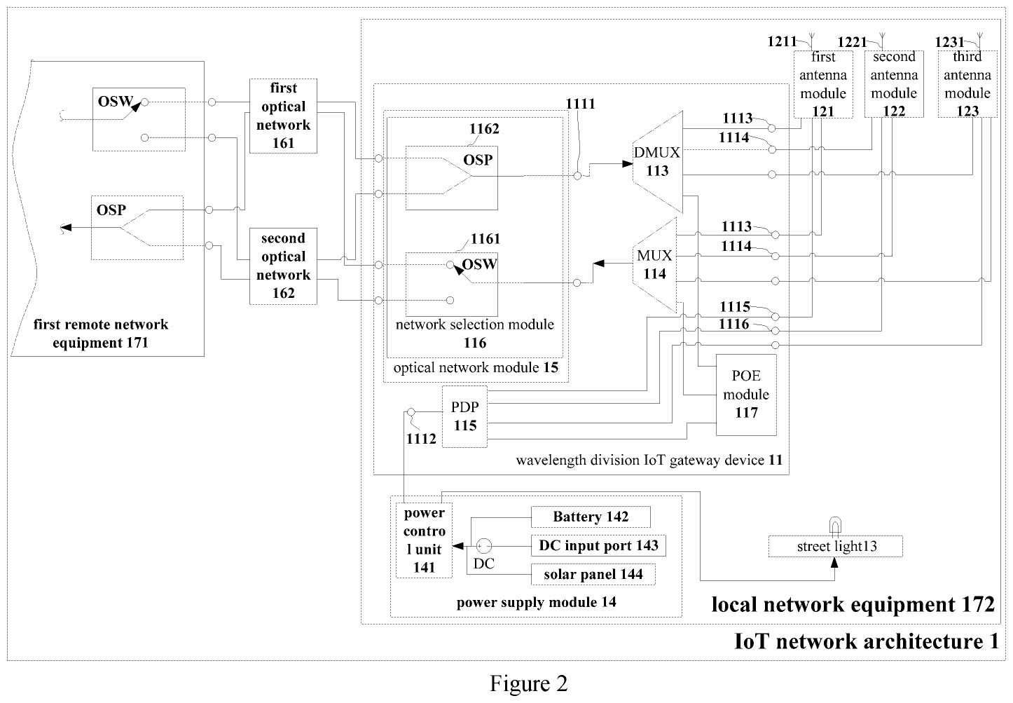

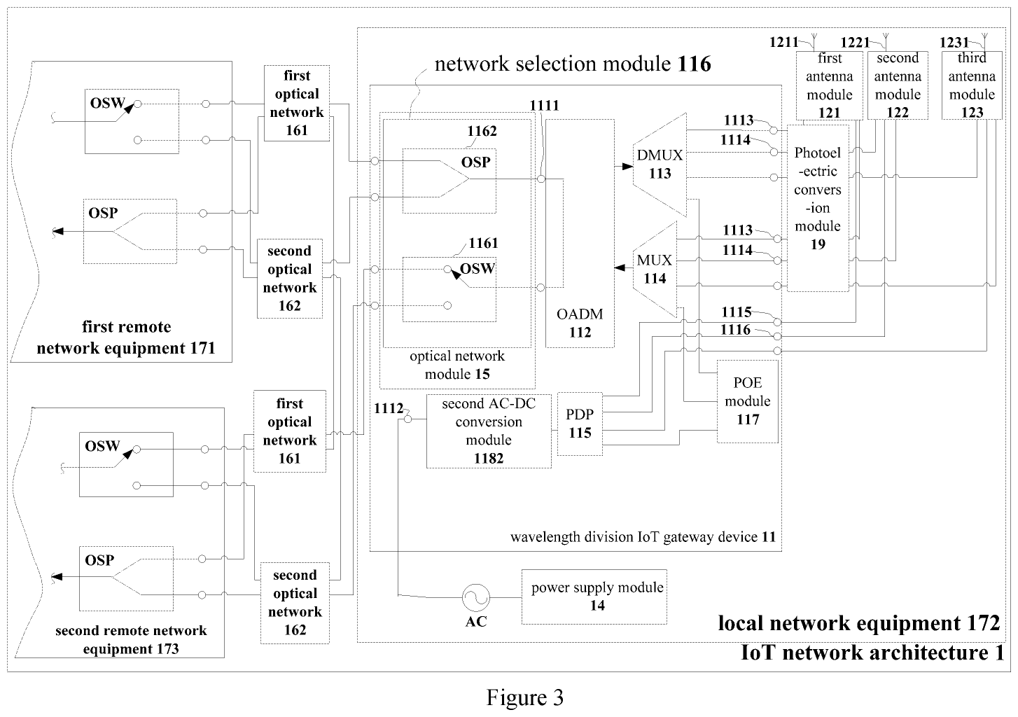

As shown in FIGS. 1 and 2, the power supply module 14 can be a DC supply module. The DC supply module includes a power control unit 141, and at least one of a battery 142, a DC input port 143 and a solar panel 144, wherein the at least one of the three components serves as a DC power supply. The power control unit 141 is used to receive DC power and provide the input power signal to the input power port 1112. Further, the power control unit 141 can provide power to the street light 13 to control lightness of the street light 13. As shown in FIGS. 3 to 6, the power supply module 14 can alternatively be an AC supply module, for providing an AC input power signal to the input power port 1112.

The first antenna module 121 is coupled to the first output optical transceiver port 1113 and the first output power port 1115. It is used to receive the first input optical signal and the first input power signal respectively from the first output optical transceiver port 1113 and the first output power port 1115, and to provide the first output optical signal to the first output optical transceiver port 1113. Preferably, as shown in FIGS. 1 to 2, the first antenna module 121 includes a first active antenna unit (AAU) 1211, as shown in FIGS. 3 to 6, the first antenna module 121 includes the first PAU 1212 and the first RRU 1213.

The second antenna module 122 is coupled to the second output optical transceiver port 1114 and the second output power port 1116. It is used to receive the second input optical signal and the second input power signal respectively from the second output optical transceiver port 1114 and the second output power port 1116, and to provide the second output optical signal to the second output optical transceiver port 1114. Preferably, as shown in FIGS. 1 to 2, the second antenna module 122 includes a second active antenna unit (AAU) 1221, as shown in FIGS. 3 to 6, the second antenna module 122 includes the second PAU 1222 and the second RRU 1223.

Accordingly, the IoT network architecture 1 further includes a optoelectric conversion module. The optoelectric conversion module 19 is used to convert the first input optical signal into an electric signal that is to be received by the first antenna module 121 having the first PAU 1212 and the first RRU 1213, and to convert an outputted electric signal into the first output optical signal such that the first antenna module 121 can provide the first output optical signal. The optoelectric conversion module 19 is also used to convert the second optical signal into an electric signal that is to be received by the second antenna module 122 having the second PAU 1222 and the second RRU 1223, and to convert an outputted electric signal into the second output optical signal such that the second antenna module 122 can provide the second output optical signal.

Preferably, the IoT network architecture 1 further includes a third antenna module 123. Accordingly, the DMUX 113 is used to further break down the input integrated optical signal into a third input optical signal that is to be transmitted to the third antenna module 123. The MUX 114 is further used to receive the third output optical signal from the third antenna module 123 and then incorporate the third output optical signal into the output integrated optical signal. The PDP 115 is used to further break down the input power signal into a third input power signal that is to be transmitted to the third antenna module 123. As shown in FIGS. 1 to 2, the third antenna module 123 includes, but not limited to, a third AAU 1231. Alternatively, as shown in FIGS. 3 to 6, the third antenna module 123 includes a third PAU 1232 and a third RRU 1233.

Preferably, the IoT network architecture 1 further includes a Power Over Ethernet (POE) module 117. Accordingly, the DMUX 113 is used to further break down the input integrated optical signal into a fourth input optical signal that is to be transmitted to the POE module 117. The MUX 114 is further used to receive a fourth output optical signal from the POE module 117 and then incorporate the fourth output optical signal into the output integrated optical signal, such that the POE module 117 can provide network function. The PDP 115 is used to further break down the input power signal into a fourth input power signal that is to be transmitted to the POE module 117, such that the POE module 117 can provide power supply function.

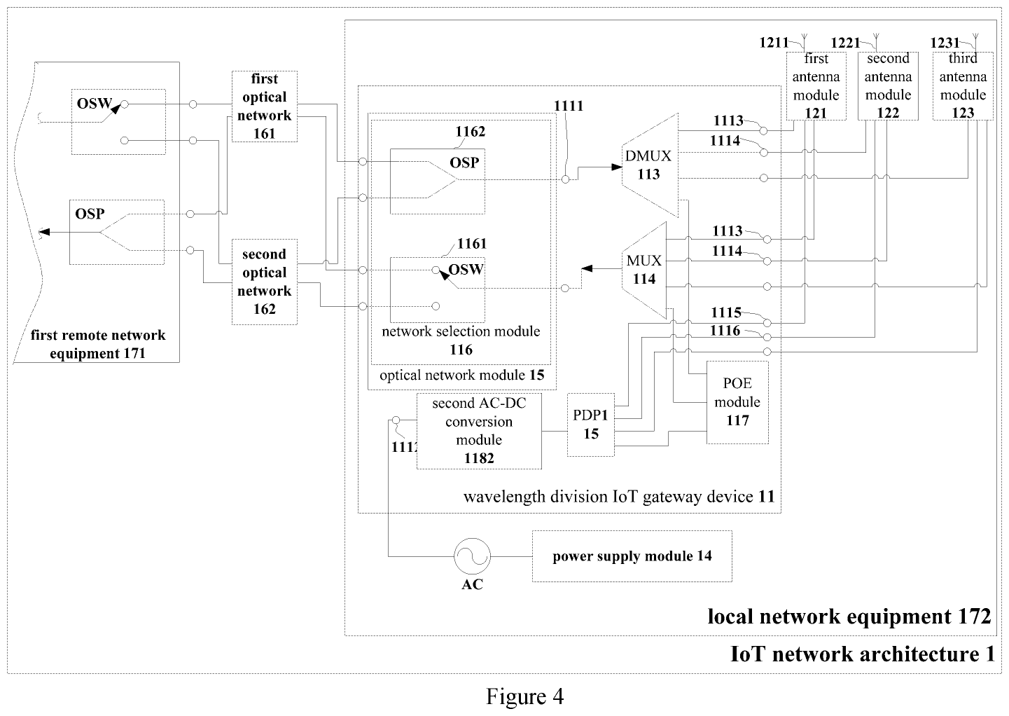

As shown in FIGS. 5 to 6, the fourth input power signal is a first AC signal, and the wavelength division IoT gateway device 11 further includes a first AC to DC conversion module 1181 for converting the fourth input power signal from the first AC signal into a first DC signal, so as to allow the POE module 117 to receive the converted fourth input power signal that is the first DC signal. The present invention is not limited to such a configuration. As shown in FIGS. 3 to 4, the input power signal is a second AC signal, and the wavelength division IoT gateway device 11 further includes a second AC to DC conversion module 1182 for converting the input power signal from the second AC signal into a second DC signal, so as to allow PDP 115 to receive the converted input power signal that is the second DC signal.

As shown in FIGS. 2, 4 and 6, the IoT network architecture 1 is applied to star network architecture, wherein the first optical network 161 and second optical network 162 are respectively connected to the first remote network equipment 171 and the local network equipment 172. The DMUX 113 is used to break down the network optical signal into the first input optical signal and the second input optical signal. The MUX 114 is used to receive the first output optical signal and the second output optical signal from the first output optical transceiver port 1113, and incorporate the first output optical signal and the second output optical signal into the network optical signal.

Accordingly, in this embodiment of the present invention, the wavelength division IoT gateway device 11 omitted the OADM, and includes the network selection module 116 connected to the first optical network 161 and the second optical network 162 respectively. In an embodiment of the present invention, when the first optical network 161 operates normally, the network selection module 116 selectively couples the first optical network 161 to the input optical transceiver port 1111 so as to allow the network optical signal to be received and sent among the first remote network equipment 171, the local network equipment 172 and the second remote network equipment 173 through the first optical network 161. When the first optical network 161 does not operate normally, the network selection module 116 selectively couples the second optical network 162 to the input optical transceiver port 1111 so as to allow the network optical signal to be received and sent among the first remote network equipment 171, the local network equipment 172 and the second remote network equipment 173 through the second optical network 162. Thus, the network selection module 116 prevents receiving and sending of the network optical signal from being affected by abnormality of the first optical network 161. Abnormality of the first optical network 161 means its optical power lower than a standard value.

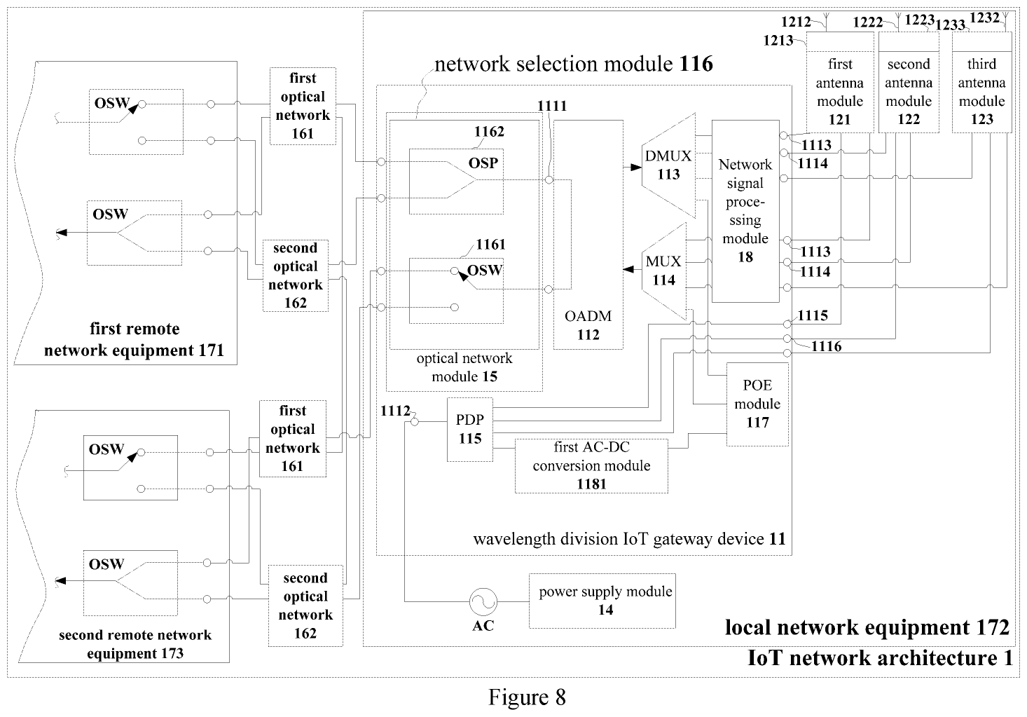

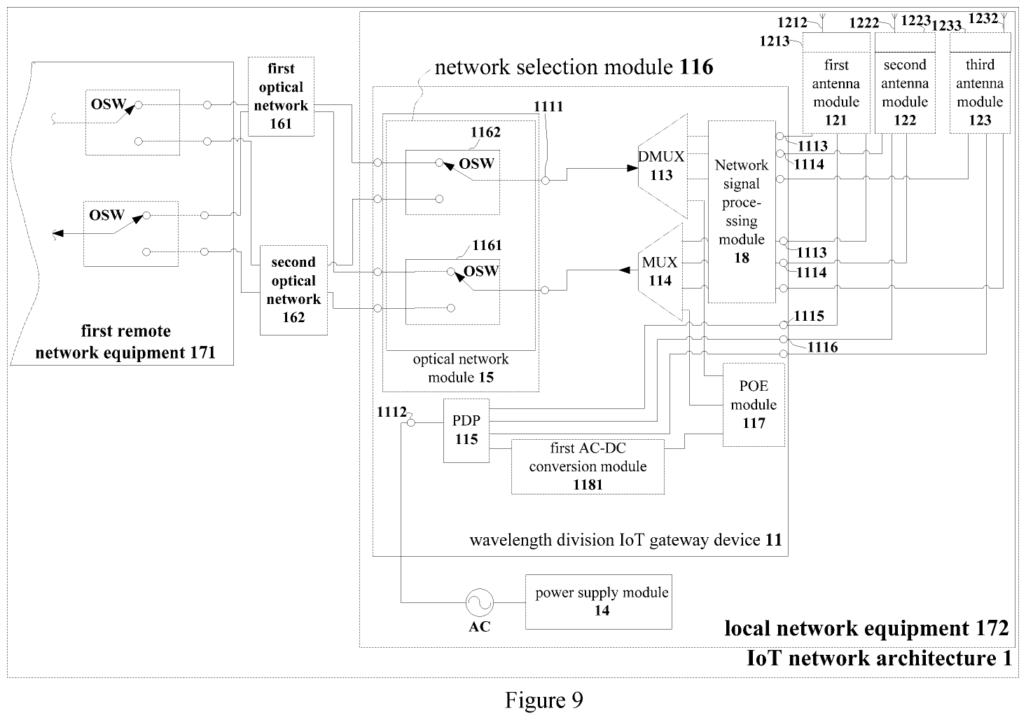

As shown in FIGS. 8 to 9, the wavelength division IoT gateway device 11 further includes a network signal processing module 18 providing such as Quality of Service (QoS) or Network Slicing. Preferably, the network signal processing module 18 is Optical Transponder Unit (OTU) composed of SDN (Software-defined networking) switch and transponder. It is used to convert an optical signal into an electric signal that is to be processed, and to again convert the processed electric signal into an optical signal.

Moreover, the network signal processing module 18 is located between the DMUX 113 and the first output optical transceiver port 1113 and the second output optical transceiver port 1114, and is used to respectively process the first input optical signal and the second input optical signal transmitted to the first output optical transceiver port 1113 and the second output optical transceiver port 1114. The network signal processing module 18 is also located between the MUX 114 and the first output optical transceiver port 1113 and the second output optical transceiver port 1114, and is used to respectively process the first output optical signal and the second output optical signal received by the first output optical transceiver port 1113 and the second output optical transceiver port 1114. Preferably, the network signal processing module 18 and the POE module 117 can be integrally formed on a single module, such that the single module can provide both network power and network signal processing.

In summary, the IoT network architecture is provided in the invention includes an optical de-multiplexer and an optical multiplexer that use wavelengths for multiplexing, such that information from different sources can be transmitted on the same optical fiber at different wavelengths in an optical network, thereby greatly improving bandwidth benefits of network information transmission and communication capacity of the gateway device so as to fulfill increasing local communication service requirements and further enhance IoT applications.

The examples above are only illustrative to explain principles and effects of the invention, but not to limit the invention. It will be apparent to those skilled in the art that modifications and variations can be made without departing from the scope of the invention. Therefore, the protection range of the rights of the invention should be as defined by the appended claims.

What is claimed is:

1. A wavelength division IoT gateway device including:
a gateway body including an input optical transceiver port, an input power port, a first output optical transceiver port, a second output optical transceiver port, a first output power port and a second output power port, wherein the input optical transceiver port is for receiving and sending a network optical signal, and the input power port is for receiving an input power signal;
an optical add/drop multiplexer (OADM) for retrieving an input integrated optical signal, which meets a predetermined input wavelength range, from the network optical signal, or for incorporating an output integrated optical signal, which meets a predetermined output wavelength range, into the network optical signal;
an optical de-multiplexer (DMUX) for breaking down the input integrated optical signal into a first input optical signal and a second input optical signal, which are to be transmitted to the first output optical transceiver port and the second output optical transceiver port respectively;
an optical multiplexer (MUX) for receiving a first output optical signal from the first output optical transceiver port and receiving a second output optical signal from the second output optical transceiver port, and for incorporating the first output optical signal and the second output optical signal into the output integrated optical signal; and
a power distribution panel (PDP) for breaking down the input power signal into a first input power signal and a second input power signal, which are to be transmitted to the first output power port and the second output power port respectively.

2. The wavelength division IoT gateway device according to claim 1, further including: a network selection module connected to a first optical network and a second optical network respectively, wherein when the first optical network operates normally, the network selection module couples the first optical network to the input optical transceiver port to allow receiving and sending of the network optical signal; when the first optical network operates abnormally, the network selection module couples the second optical network to the input optical transceiver port to allow receiving and sending of the network optical signal.

3. The wavelength division IoT gateway device according to claim 2, wherein abnormality of the first optical network means the first optical network's optical power lower than a standard value.

4. The wavelength division IoT gateway device according to claim 2, wherein the network selection module at least is composed of an optical switch (OSW) and an optical splitter (OSP) or the network selection module at least is composed of a plurality of OSWs.

5. The wavelength division IoT gateway device according to claim 1, further including: a Power Over Ethernet (POE) module, wherein the DMUX is for further breaking down the input integrated optical signal into a fourth input optical signal that is to be transmitted to the POE module; the MUX is further for receiving a fourth output optical signal from the POE module and then for incorporating the fourth output optical signal into the output integrated optical signal; the PDP is for further breaking down the input power signal into a fourth input power signal that is to be transmitted to the POE module.

6. The wavelength division IoT gateway device according to claim 5, wherein the fourth input power signal is a first AC signal, and the wavelength division IoT gateway device further includes a first AC to DC conversion module for converting the fourth input power signal from the first AC signal to a first DC signal, allowing the POE module to receive the fourth input power signal that is the first DC signal.

7. The wavelength division IoT gateway device according to claim 1, wherein the input power signal is a second AC signal, and the wavelength division IoT gateway device further includes a second AC to DC conversion module for converting the input power signal from the second AC signal into a second DC signal, so as to allow PDP to receive the converted the input power signal that is the second DC signal.

8. The wavelength division IoT gateway device according to claim 1, wherein the input optical transceiver port and the input power port can be integrally formed in a first optoelectric hybrid cable connector; the first output optical transceiver port and the first output power port can be integrally formed in a second optoelectric hybrid cable connector; the second output optical transceiver port and the second output power port can be integrally formed in a third optoelectric hybrid cable connector.

9. The wavelength division IoT gateway device according to claim 1, further including: a network signal processing module, wherein the network signal processing module is located between the DMUX and the first output optical transceiver port and second output optical transceiver port, and is for respectively processing the first input optical signal and the second input optical signal transmitted to the first output optical transceiver port and the second output optical transceiver port, and wherein the network signal processing module is located between the MUX and the first output optical transceiver port and the second output optical transceiver port, and is for respectively processing the first output optical signal and the second output optical signal received by the first output optical transceiver port and the second output optical transceiver port.

10. A wavelength division IoT gateway device including:
a gateway body including an input optical transceiver port, an input power port, a first output optical transceiver port, a second output optical transceiver port, a first output power port and a second output power port, wherein the input optical transceiver port is for receiving and sending a network optical signal, and the input power port is for receiving an input power signal;
an optical de-multiplexer (DMUX) for breaking down the network optical signal into a first input optical signal and a second input optical signal, which are to be transmitted to the first output optical transceiver port and the second output optical transceiver port respectively;
an optical multiplexer (MUX) for receiving a first output optical signal from the first output optical transceiver port and receiving a second output optical signal from the second output optical transceiver port, wherein the first output optical signal and the second output optical signal are to be incorporated into the network optical signal; and
a power distribution panel (PDP) for breaking down the input power signal into a first input power signal and a second input power signal, which are to be transmitted to the first output power port and the second output power port respectively.

11. The wavelength division IoT gateway device according to claim 10, further including: a network selection module connected to a first optical network and a second optical network respectively, wherein when the first optical network operates normally, the network selection module couples the first optical network to the input optical transceiver port to allow receiving and sending of the network optical signal; when the first optical network operates abnormally, the network selection module couples the second optical network to the input optical transceiver port to allow receiving and sending of the network optical signal.

12. The wavelength division IoT gateway device according to claim 11, wherein abnormality of the first optical network means the first optical network's optical power lower than a standard value.

13. The wavelength division IoT gateway device according to claim 11, wherein the network selection module at least is composed of an optical switch (OSW) and an optical splitter (OSP) or the network selection module at least is composed of a plurality of OSWs.

14. The wavelength division IoT gateway device according to claim 1, further including: a Power Over Ethernet (POE) module, wherein the DMUX is for further breaking down the input integrated optical signal into a fourth input optical signal that is to be transmitted to the POE module; the MUX is further for receiving a fourth output optical signal from the POE module and then for incorporating the fourth output optical signal into the output integrated optical signal; the PDP is for further breaking down the input power signal into a fourth input power signal that is to be transmitted to the POE module.

15. The wavelength division IoT gateway device according to claim 14, wherein the fourth input power signal is a first AC signal, and the wavelength division IoT gateway device further includes a first AC to DC conversion module for converting the fourth input power signal from the first AC signal to a first DC signal, allowing the POE module to receive the fourth input power signal that is the first DC signal.

16. The wavelength division IoT gateway device according to claim 10, wherein the input power signal is a second AC signal, and the wavelength division IoT gateway device further includes a second AC to DC conversion module for converting the input power signal from the second AC signal into a second DC signal, so as to allow PDP to receive the converted the input power signal that is the second DC signal.

17. The wavelength division IoT gateway device according to claim 10, wherein the input optical transceiver port and the input power port can be integrally formed in a first optoelectric hybrid cable connector; the first output optical transceiver port and the first output power port can be integrally formed in a second optoelectric hybrid cable connector; the second output optical transceiver port and the second output power port can be integrally formed in a third optoelectric hybrid cable connector.

18. The wavelength division IoT gateway device according to claim 10, further including: a network signal processing module, wherein the network signal processing module is located between the DMUX and the first output optical transceiver port and second output optical transceiver port, and is for respectively processing the first input optical signal and the second input optical signal transmitted to the first output optical transceiver port and the second output optical transceiver port, and wherein the network signal processing module is located between the MUX and the first output optical transceiver port and the second output optical transceiver port, and is for respectively processing the first output optical signal and the second output optical signal received by the first output optical transceiver port and the second output optical transceiver port.

19. An IoT network architecture including:
the wavelength division IoT gateway device according to claim 1;
a first antenna module coupled to the first output optical transceiver port and the first output power port, for receiving the first input optical signal from the first output optical transceiver port and for providing the first output optical signal to the first output optical transceiver port;
a second antenna module coupled to the second output optical transceiver port and the second output power port, for receiving the second input optical signal from the second output optical transceiver port, and for providing the second output optical signal to the second output optical transceiver port;
a power supply module coupled to the input power port, for providing the input power signal to the input power port; and
an optical network module coupled to the input optical transceiver port, for providing the network optical signal to the input optical transceiver port.

20. The IoT network architecture according to claim 19, further comprising: a optoelectric conversion module for converting the first input optical signal into an electric signal that is to be received by the first antenna module, and for converting an outputted electric signal into the first output optical signal that is to be provided by the first antenna module:
the second input optical signal into an electric signal that is to be received by the second antenna module, and for converting an outputted electric signal into the second output optical signal that is to be provided by the second antenna module.
